(19) United States
(12) Patent Application Publication
(10) Pub. No.: US 2007/0006892 A1
(43) Pub. Date: Jan. 11, 2007

(54) Uniform, far-field megasonic cleaning method and apparatus

(75) Inventors: Michael B. Olesen, Brentwood, CA (US); Mario E. Bran, Tustin, CA (US); Kenneth C. Struven, San Carlos, CA (US); Paul V. Mendes, Morgan Hill, CA (US)

Correspondence Address: Harris Zimmerman;Law Offices of Harris Zimmerman, Suite 710, 1330 Broadway, Oakland, CA, 94612, US

(73) Assignee: Imtec Acculine, Inc.

(21) Appl. No.: 11/341,401

(22) Filed: Jan. 26, 2006

Related U.S. Application Data
(60) Provisional application No. 60/697,793, filed on Jul. 8, 2005.
(60) Provisional application No. 60/736,678, filed on Nov. 15, 2005.

(51) Int. Cl. B08B 3/12; B08B 6/00

(52) U.S. Cl. 134/1; 134/184

(57) ABSTRACT

A method and apparatus for megasonic cleaning of substrates by placing the wafers in the far-field megasonic zone to eliminate sonic-induced damage to highly sensitive small-scale device structures that occurs in the near-field megasonic zone. Folded acoustic beam paths are defined by at least one reflector to achieve sufficient path length to the wafers. A reciprocally rotating reflector may be used to sweep the acoustic beam across the substrate surfaces.

### CROSS-REFERENCE TO RELATED APPLICATIONS

This application claims the benefit of the priority filing dates of Provisional Applications No. 60/697,793, filed Jul. 7, 2005, and No. 60/736,678, filed Nov. 15, 2005.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to a method and apparatus for megasonic cleaning and, more particularly, to the provision of an all-far-field megasonic field to impinge on and clean the surfaces of wafers undergoing cleaning.

In the production and manufacture of electrical components, it is a recognized necessity to be able to clean, etch or otherwise process substrates to an extremely high degree of cleanliness and uniformity. Various cleaning, etching, or stripping processes may be applied to the substrates a number of times in conjunction with the manufacturing steps to remove particulates, pre-deposited layers or strip resist, and the like.

One cleaning process that is often employed involves ultrasonic cleansing; that is, the application of high frequency ultrasonic energy to the substrates in a liquid bath. More specifically, the ultrasonic energy is generally, but not limited to, the range of 0.50-10.00 MHz, and the process is termed megasonic cleaning. Films and residues take the form of organic polymers, metals, metal ions, and general particulate debris. Removal of particles and many organic residues require overcoming adhesion forces which bind them to the surface being cleaned. The principle adhesion forces for such contaminants are due to:

1) van der Waals force; 2) Ionic double layer force (Zeta Potential); 3) Electrostatic forces; 4) Capillary condensation; and, 5) Hydrophilic and hydrophobic interactions.

Removal mechanisms which overcome these forces are categorized as three main types: 1) Chemical dissolution and/or decomposition forces such as RCA-type cleaners; 2) Hydrodynamic drag forces such as spraying and scrubbing (both of which affect the boundary conditions of small surface features; and, 3) Acoustic forces such as ultrasonic and megasonic energy (which also affect the boundary conditions). These removal techniques may be combined in various ways. Acoustic forces have become widely accepted as the best method for lifting and removing debris from hard to clean semiconductor topographies in both cleaning and rinsing applications as part of wet chemical processing of wafers.

It is apparent that it is vitally important for the acoustic cleaning process to remove the maximum amount of contaminants from the wafer surfaces without causing damage to the vulnerable topography on the wafer surfaces. As the critical dimensions of semiconductor structures have shrunk in size they have become as small as the particles and debris that must be removed by the cleaning processes. In many instances such as the cleaning of poly gate stack structures where the line widths are less than 100 nm and the aspect ratios are approximately 5:1, the cleaning processes may actually lift the lines from the surface, causing device failure. The best known cleaning methods, such as spraying, scrubbing, and megasonic energy, are destructive in these smaller geometry domains. Limiting the use of these methods may serve to reduce damage to surface features, but the result is a tradeoff against an increase in residual surface contamination which may cause device failure as well. There is a need in the prior art for techniques that are capable of cleaning these smaller surface features without damaging them.

2. Description of Related Art

In U.S. Pat. No. 6,890,390, Azar defines a method for cleaning a substrate using ultrasonic energy from a phased transducer array where the signal amplitude and phase fed to the array elements are controlled to focus or steer the ultrasonic energy to each location on the substrate. It describes a method to electronically direct the sonic energy in a moving beam, without requiring a physically moving element in the cleaning tank. Azar also distinguishes near-field and far-field zones in the ultrasonic field, and defines the transition zone between the two as Z_{TR}=D²/4λ, where D is the overall dimension of the array, and λ is the sonic wavelength in the fluid medium. However, this patent does not attach any significance to the near-field versus the far-field, in relationship to damage to very small structures on the substrate surface.

Other patents describe various arrangements for moving the wafer substrates within the sonic near-field to distribute the average sonic energy on the wafer surfaces in order to reduce “hot spots”, that may cause surface damage, as well as to reduce the “shadowing” effect of the cassette. They include devices to rotate the wafers about their central axes within the tank, move the wafer or sonic transducer device back and forth, or to rock the cassette in which the wafers are supported adjacent to the ultrasonic transducer in the tank. These techniques may overcome the “shadowing” effect of the cassette structures on the wafers. However, they do not prevent sonic induced damage to small-scale surface features by the hot spots of near-field megasonic energy, because they do not reduce the sonic intensity gradient of the near-field, they merely move the wafer through it quicker. The hot spot remains and continues to cause structural damage.

### BRIEF SUMMARY OF THE INVENTION

The present invention generally comprises a method and apparatus for megasonic cleaning of wafers and the like. In general, the invention describes a method and apparatus for megasonic cleaning by placing the wafers in the far-field megasonic zone, thereby eliminating the sonic-induced damage to highly sensitive small-scale device structures that occurs in the near-field megasonic zone. The invention describes several techniques for creating the far-field zone within the confines of a standard-size cleaning tank.

The discovery that megasonic cleaning in the far-field zone results in little or no damage to small-scale structures follows from research undertaken by the inventors. For example, FIG. 1 shows photomicrographic images of typical substrate portions with small-scale 45 nm poly-line structures, all processed at differing distances from the transducer but at a same energy density flux of 3.27 w/cm² at the surface of the transducer. The left encircled areas show 600× magnification of the 45 nm lines, and white spots and blemishes indicate damage or discontinuities in the lines. Note that the very-near-field (VNF), approximately 1 mm from the sonic emitter, the sonic energy creates very heavy damage, the near-field (NF) creates heavy damage, while the far-field (FF) generates light damage, even though the average acoustic power density is the same in all cases.

FIG. 2 shows photomicrographic images of typical substrate portions with small-scale 45 nm poly-line structures, processed at differing distances from the transducer, the FF and NF, with different energy density fluxes, 3.27 w/cm², and 1.27 w/cm² at the surface of the transducer. This figure shows a clear difference in damage density between the FF and NF, and also shows that with medium power densities (1.27 w/cm²) the surface is damage-free.

FIG. 3 shows photomicrographic images of typical substrate portions with small-scale features formed on the surfaces. The left column presents the substrate portions before undergoing cleaning, the right column shows the results of the cleaning process. From top to bottom, the 1st row depicts the results with no megasonic energy used; the 2^{nd} row shows the substrate cleaned in the very near-field (approximately 1 mm from the sonic emitter) at a sonic flux of 3.27 w/cm²; the 3^{rd} row shows the substrate cleaned in the near-field at a sonic flux of 3.27 w/cm²; and the 4^{th} row shows the substrate cleaned in the far-field, also at a sonic flux of 3.27 w/cm². Black dots and blemishes indicate residual contamination. The post-clean examples, after any of the megasonic processes, are completely clean, demonstrating that efficient cleaning occurs at all distances. Given that the flux density for FIGS. 1 and 3 was the same for all samples, it is clear that the far-field zone is far superior in terms of achieving a high level of cleanliness and a low level of damage to the surface structures.

FIG. 4 describes a 2-D model (right) of the sonic propagation showing the near and far-fields where 10 is the highest relative intensity, and 0 the least. The Z_{TR} is based on the width of the transducer element being 35 mm, and shows that the sonic intensity becomes more uniform with a low gradient in the far-field, while it has an extremely non-uniform and high gradient in the near-field. The very-near-field zone occurs in the very highest sonic intensity region (10). A 200 mm wafer map (center) is shown relative to the 2D-model (right) showing the effect of sonic induced damage caused by megasonic cleaning in the NF region. The black markings and areas are damage points. From this model and wafer map, it is easy to see how the sonic intensity in the very-near and near-fields can create the catastrophic sonic induced damage seen in the photomicrographs above (FIGS. 1 and 2), and the far-field does not since sonic intensity is directly proportional to the formation of higher density and stronger cavitations in the liquid believed to be the primary cause of the sonic induced damage.

FIG. 5 plots the distance Z_{TR} to the far-field region as a function of the width D, of a rectangular acoustic emitter. This plot assumes that the wafer orientation is generally perpendicular and at a right angle to the long axis of the rectangular acoustic transducer. Clearly, the greater the width of the transducer, the greater the distance to the start of the far-field region.

In one aspect, the invention includes a tank that accepts a cassette holding a plurality of wafers, with a transducer array disposed below the cassette and directed laterally within the tank. A moving acoustic reflector is disposed beneath the cassette in the path of the beam from the transducers. The reflector is driven to reciprocate angularly and reflect the incident acoustic beam toward various portions of the wafers supported on the cassette above the reflector. The total path length from the transducers to the reflector and thence to the wafers is greater than the distance Z_{TR}, so that the wafer surfaces are necessarily disposed in the far-field region. This factor was proven by the inventors and results in a significant reduction in sonically-induced damage to small surface geometries as low as 45 nm, and possibly smaller (FIGS. 1 and 2).

In addition, the reflector distributes the far-field energy in an angular scan through a solid angle that illuminates the wafer surfaces in a generally uniform manner, so that the peak and average acoustic energies incident on the wafer surfaces are generally constant across those surfaces. This distribution creates a fairly uniform cleaning effect across all wafer surfaces.

The reflector may take the form of an elongated panel or vane which extends generally longitudinally with respect to the width of the acoustic beam emitted from the transducers. The vane is mounted to be rotated reciprocally about the longitudinal axis and deflect the acoustic beam toward the wafer in the cassette disposed superjacently thereto. The reflectivity of the vane may be assured by dimensioning the vane to have a thickness that falls within a ¼ λ interval of the resonant frequency of the chosen reflective material (typically, but not limited to, quartz, aluminum, silicon carbide and the like) at the megasonic frequency being used. Alternatively, the reflector may comprise a prism having facets disposed to generate the desired angular deflection of the acoustic beam. Those versed in the art will understand that typically, where the term “reflector” is used, a properly configured acoustic lens, or “refractor” would be serviceable. In either case, the facets of the reflector may be provided with a surface treatment (dimpled, lenticular, bead-blasted, etc) to diffuse the acoustic energy field. Likewise the surface treatment may comprise curved facets that serve to focus or spread the incident acoustic beam to achieve desired directional control and power density levels.

In another aspect, the invention provides twin opposed transducer arrays which can be at different frequencies and power levels from each other, i.e. 1 MHz at _power, directed toward an acoustic reflector disposed medially therebetween. The two transducer arrays provide enhanced uniformity in acoustic power levels delivered to the wafer surfaces from the reflector element. Note that the reflector element may be mounted to move not only rotationally on its longitudinal axis, but also to translate vertically and reciprocally to eliminate ¼ λ and ½ λ nodes in the sonic field.

In a further aspect, the invention provides at least one transducer array in which a plurality of transducers are in adjacent mountings and are driven in phase to generate a collimated acoustic beam that is directed along a Centrally Radiating Axis (CRA), toward the wafers in the far-field region. The in-phase, collimated nature of the beam significantly reduces the radial non-uniformity of the sonic field from the bottom to the top of the wafers, as compared to other prior art arrangements where the beam is not collimated and is utilized in the near-field by requirement of the CRA. The in-phase collimated CRA beam also allows for elimination of cassette or holder shadowing of the sonic field. It enables the cleaning of all wafer surfaces, front-side, back-side, and edges not possible in competing “single-wafer” approaches which also claim damage-free megasonic cleaning. It also reduces the number of megasonic transducers needed to give complete coverage to the wafers, thereby reducing the total watts necessary to achieve watt densities sufficient to clean the wafers. And due to the unique method of combining the CRA beam with a moving reflector element, it enables the invention to create the All-Far-Field sonic target area in which the wafers are held for cleaning.

A further advantage of the moving reflector's “folded”, in-phase, collimated CRA beam is that it reduces the distance at which the near-field acoustic zone transitions to the far-field. Note that the distance to the far-field varies with the square of the transducer dimension D, as described above in the equation for Z_{TR}. Given the fact that the typical transducer assembly is rectangular, it has been observed that the value of D for the in-phase, collimated CRA beam is approximately equal to the short side dimension of the rectangular transducer assembly. This effect yields a shorter Z_{TR} distance; indeed, this distance is decreased sufficiently so that it is achievable in a path length provided by the folded-direction acoustic path defined by the reflector element. Thus there is a synergy created by the combination of the reflector element and the in-phase, collimated CRA acoustic beam.

In another aspect of the invention, the tuning frequency of the transducer can be shifted above or below the anti-resonate point by approximately 25 KHz. This has been shown by the inventors and others to have positive effects on sonic uniformity of the transmitted beam. The inventors have also found that the matching impedance of the transducer to generator can also be intentionally mismatched to assist in the reduction of sonically induced damage. In addition, the driver signal may be amplitude, frequency or phase modulated to enhance the cleaning properties and reduce the damage caused by the megasonic field.

In other aspects of the invention, transducer arrays formed of narrow parallel acoustic elements, or an array of rows of small, point-source-like elements, may be provided to transmit directly (non-reflected), nearby the wafer, or plurality of wafer substrates in the sonic cleaning bath. These acoustic elements may each be driven with a signal of proper amplitude and phase to form a beam that has a very small effective Z_{TR}, so that the wafers are not exposed to near-field sonic energy from the transducers.

### BRIEF DESCRIPTION OF THE DRAWING

FIG. 1 is a composite of photomicrographs, showing substrates having 45 nm poly lines with sonic induced damage comparing the very near-field (VNF), near-field (NF), and far-field (FF) at the same high power density

FIG. 2 is a composite of photomicrographs, showing substrates having 45 nm poly lines with and without sonic induced damage comparing the NF and FF at high and medium power densities

FIG. 3 is a composite of photomicrographs showing the relative cleaning versus VNF, NF, and FF regions at the same power density.

FIG. 4 describes a 2D model of sonic intensity mapping showing the relative Z_{TR} for a given transducer element with a laser map of a device wafer showing sonic induced damage in the NF.

FIG. 5 is a graph depicting the distance from a megasonic transducer versus the width of the transducer, noting the beginning of the far-field region for two different frequencies.

FIG. 6 is a schematic elevation of a direct, non-reflecting, short path length transducer array for achieving a far-field region using multiple narrow transducers.

FIG. 7 is a plan view of the transducer arrangement of FIG. 6, showing the critical wafer orientation for that embodiment.

FIG. 8 is a plan view of an alternative transducer arrangement, showing the non-critical wafer orientation for that embodiment.

FIG. 9 is a schematic view of a megasonic cleaning bath featuring a narrow transducer firing an acoustic beam toward a reciprocating rotating reflector to sweep the beam across the wafers along a CRA.

FIG. 10-11 are top and side views of a megasonic cleaning bath as in FIG. 9.

FIG. 12 is a schematic view of a megasonic cleaning bath featuring a reciprocating rotating prism reflector.

FIG. 13 is a schematic view of a megasonic cleaning bath employing a reflector, depicting the convergence of the surface-reflected acoustic beam with the primary beam emitted from the transducer.

FIG. 14 is a schematic view as in FIG. 13, showing the use of a baffle plate to prevent interference between the reflected and primary acoustic beams.

FIGS. 15-19 are schematic views of further megasonic cleaning baths employing multi-reflector acoustic paths to achieve far-field megasonic cleaning.

FIG. 20 is a graphic depiction of the acoustic beam sweep of the embodiment of FIG. 16.

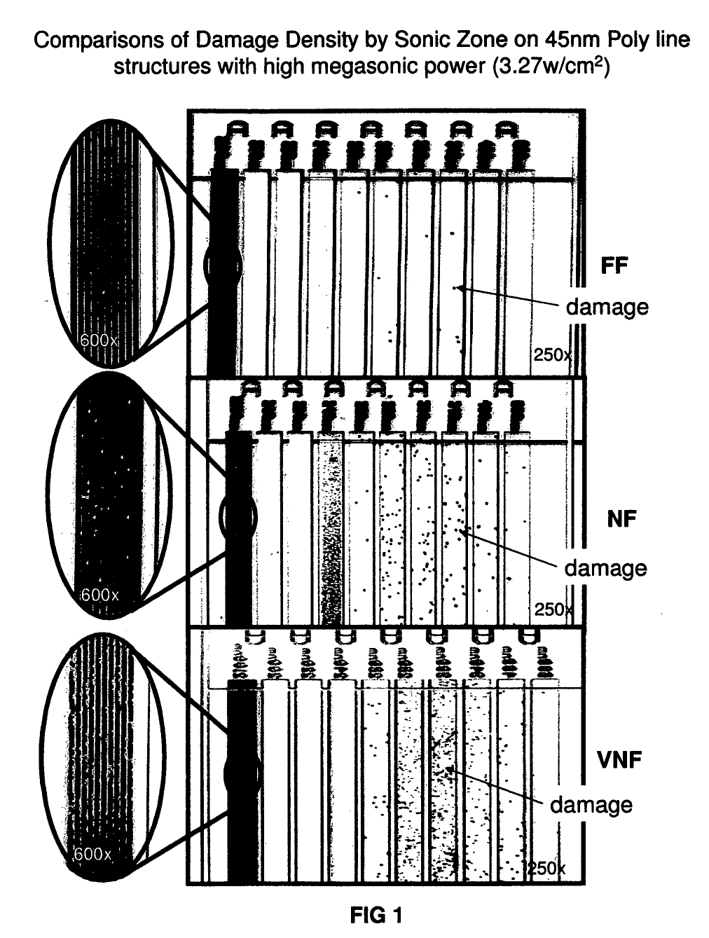

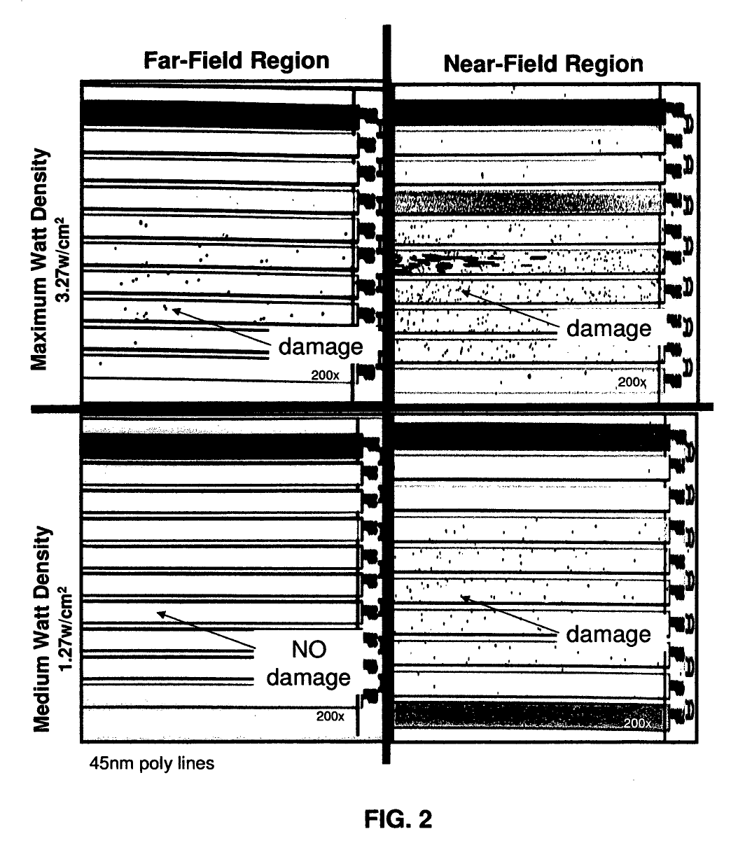

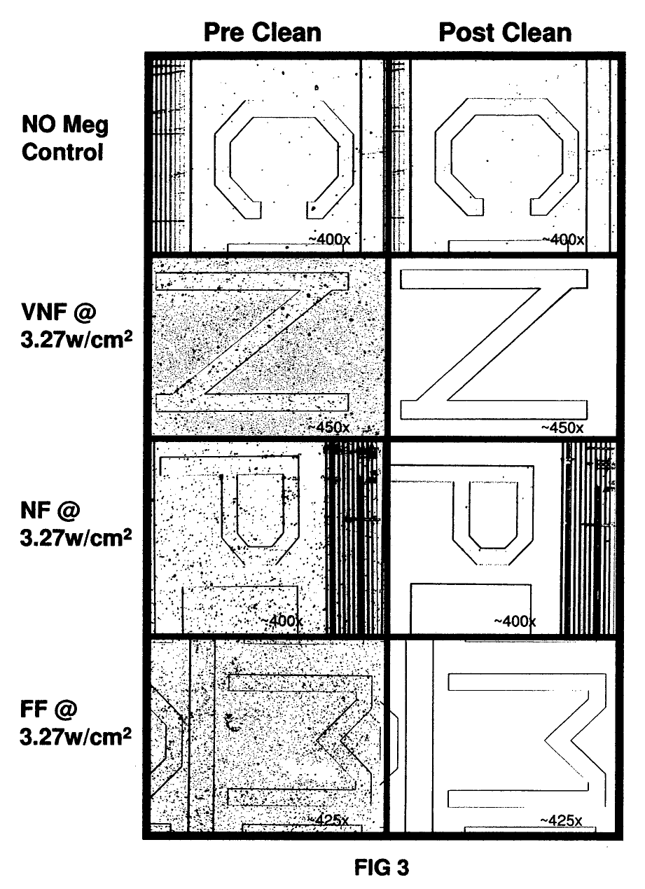

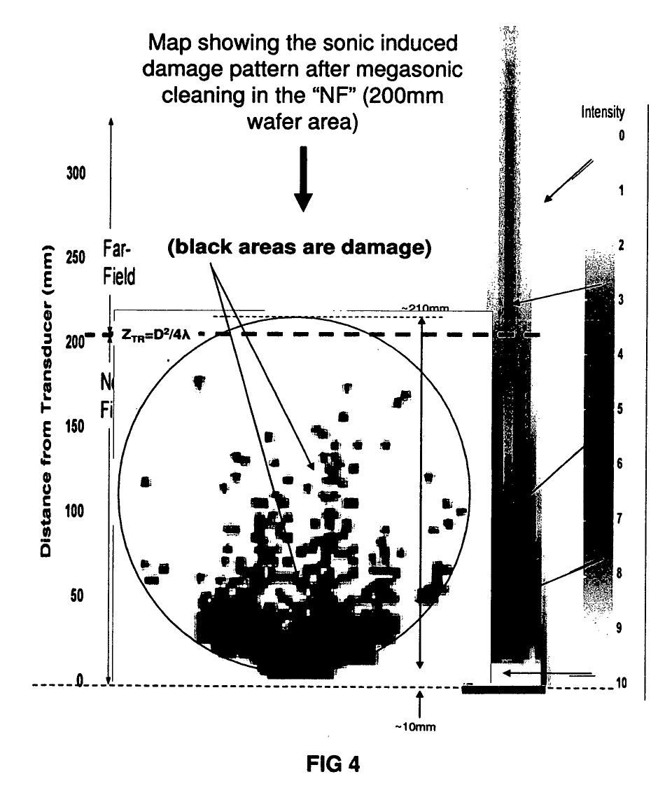

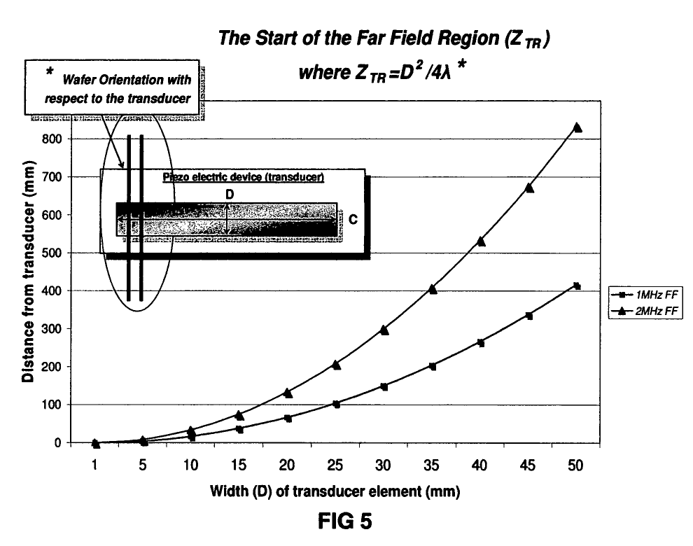

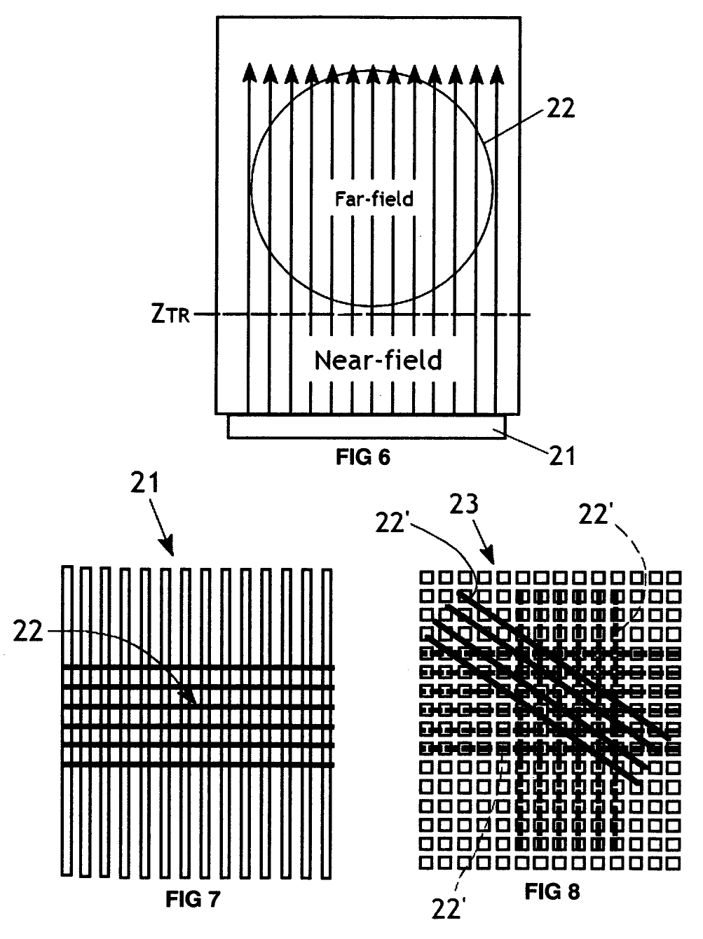

### DETAILED DESCRIPTION OF THE INVENTION

The present invention generally relates to wafer megasonic cleaning baths in which the wafers are protected from sonic damage by placing the wafers in the far-field sonic region. Noting that the distance to the far-field transition, Z_{TR}=D²/4λ, where D is the smallest of the two rectangular dimensions (as identified as “D” in FIG. 5) of the array, and λ is the sonic wavelength in the fluid medium, it is clear that this distance to the far-field may be reduced either by increasing the wavelength (reducing the megasonic frequency) or decreasing the overall dimension of the array, D. It is possible to use a plurality of small transducers and take advantage of their small D value, as long as the plurality of transducers does not act as a single large acoustic emitter, in which case the D value will be much higher. This condition may be met by providing sufficient spacing between the individual small emitters to ensure their independent action and non-interference with adjacent emitters. In this regard the sufficient spacing dimension is limited by a factor of λ/2, since any spacing equal to or less than this value would appear as no space whatsoever, and the D value would equal the maximum dimension of the transducer array layout. On the other hand, the greater the spacing between transducers the more independent they will be from their neighboring transducers. Typically, a spacing of 2-10λ would be adequate.

With regard to FIGS. 7 and 8, one arrangement embodying this concept includes a plurality of transducers 21 having a very high height/width ratio. The transducers are spaced as described above, and it is important that the wafers 22 undergoing cleaning are disposed perpendicularly and at a right angle to the long axes of the transducers 21. These conditions enable the transducers to be fired together from the same signal generator, and the sufficient spacing enables the transducers to act as independent emitters and create a far-field megasonic acoustic zone that is relatively close to the transducers. With regard to FIG. 8, an array 23 of small acoustic transducers may be constructed, again with the spacing constraints described above. The transducers are spaced sufficiently to act as independent emitters, so that the far-field distance calculation is predicated on a small value for D. A noted advantage of the embodiment of FIG. 8 is that the wafers 22′ need not be oriented in any particular angular alignment with respect to the transducers; rather, any orientation is acceptable, as suggested by the wafers 22′ shown in broken line. Note that in both embodiments of FIGS. 7 and 8 the transducers may be driven so that the individual elements fire sequentially, or in sequential groupings, provided that adjacent groups of transducers are not fired together.

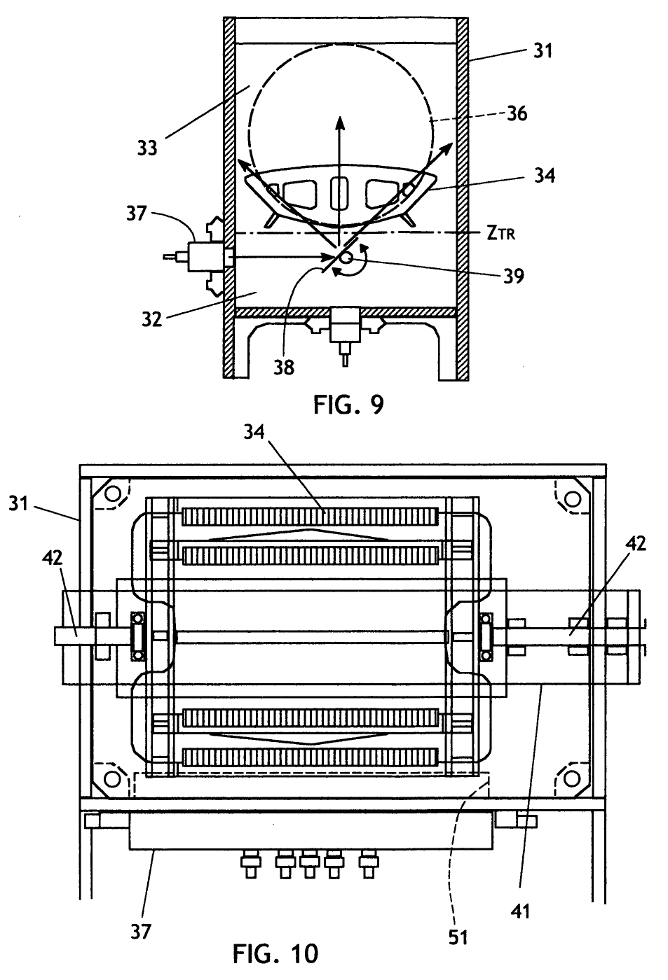

Another approach to the goal of performing megasonic cleaning in the far-field region involves folding the acoustic beam within the confines of a cleaning tank. With regard to FIG. 9, a megasonic cleaning bath includes a tank 31 having a lower sump portion 32 and an upper portion 33 arranged to receive a cassette 34 that supports a plurality of wafers 36 undergoing cleaning. The wafers 36 are supported in parallel, in a spaced apart fashion so that the cleaning solvent and megasonic energy may contact their surfaces. An acoustic transducer 37 is mounted on the sump portion 32 of the tank and configured to emit an acoustic beam that is narrow in the vertical direction and wide in the horizontal direction, so that the beam is generally planar and extends perpendicularly to the drawing plane. An acoustic reflector 38 is disposed in the sump region and placed directly in the path of the planar acoustic beam from transducer 37. The reflector is supported on a rotating mounting 39 that rotates reciprocally through an angular range about an axis disposed in the plane of the acoustic beam, so that all of the acoustic beam is reflected generally upwardly into the upper portion 33 of the tank. The reflector is shown at various angular positions to illustrate the fact that the beam is swept across the wafers, but the angles depicted are not necessarily to scale.

The reflector 38 serves two significant purposes: 1) to define an acoustic beam path length that is greater than the distance to Z_{TR}; and, 2) to sweep the acoustic beam from a CRA across the wafer(s) 36 in the cassette 34 and distribute the megasonic energy uniformly across the surfaces. The reflectivity of the vane may be assured by fabricating the vane in quartz (or other materials) and dimensioning it to have a thickness that falls within a ¼λ interval of the resonant frequency for quartz (or the other suitable materials) at the megasonic frequency being used. The resulting cleaning in the far-field region, with uniform and controlled cavitation, is optimal in terms of removing the most debris and contamination from the wafer surfaces while creating the least amount of physical damage to the structures on those surfaces.

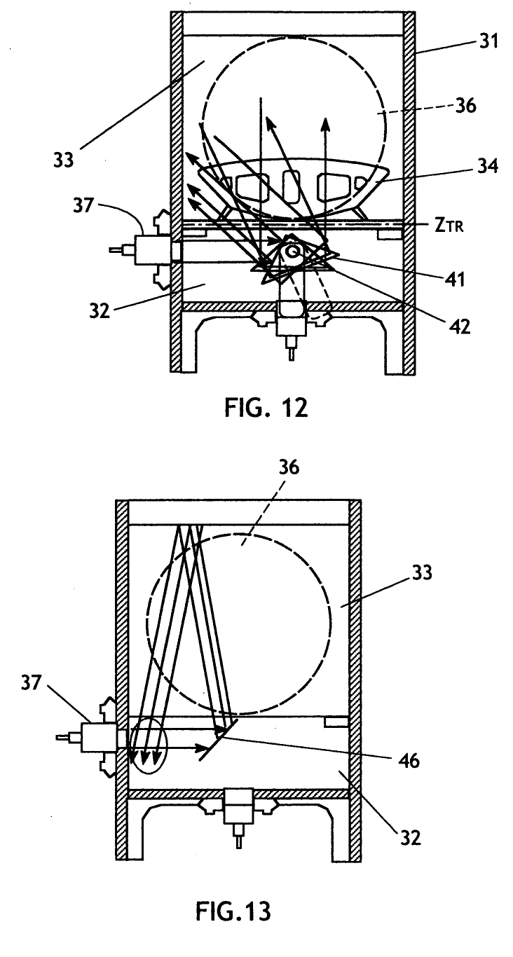

A further embodiment of the reflector concept, shown in FIG. 12, employs the same general tank and transducer arrangement of FIG. 9, and the components common to both embodiments are accorded the same reference numerals. In this embodiment a reflective prism 41 is provided in place of the reflector 38, and mounted on a reciprocating rotational mount 42 that rotates about an axis that lies within the plane of the acoustic beam. The prism 41 is provided with facets that are angled to provide the desired reflection (or refraction) of the acoustic beam to sweep the beam across the surfaces of wafers 36. The prism may be fabricated of quartz or any other suitable material. As shown in FIG. 12, the prism may be rotated reciprocally through a suitable angular range to deflect or refract the acoustic beam, so that the beam sweeps and traverses a sufficient angle to contact all the surfaces of all the wafers, which are entirely in the far-field region.

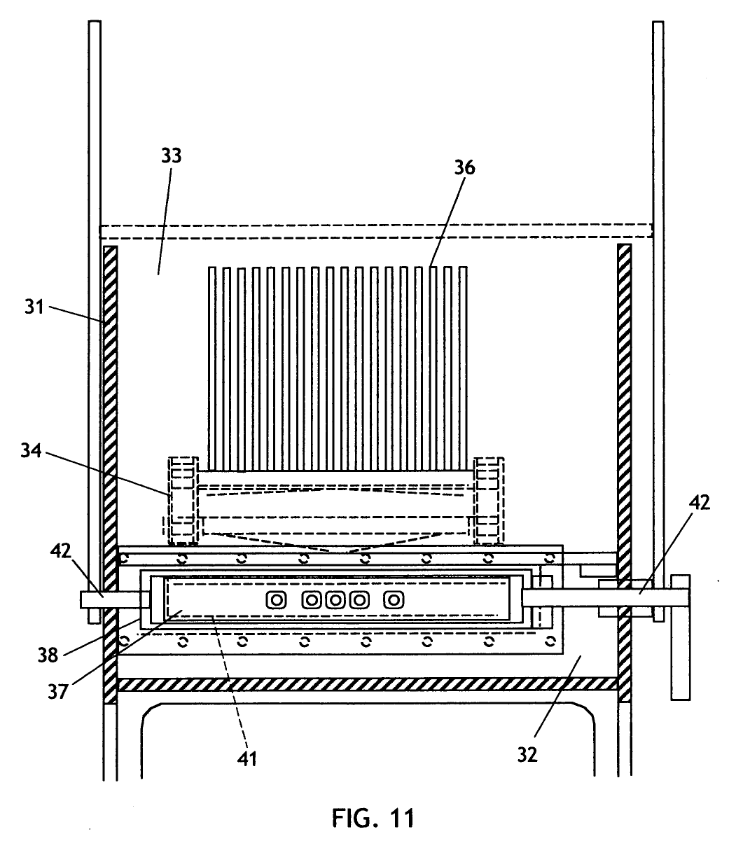

With regard to FIGS. 10 and 11, the transducer 37 is shown more clearly as a rectangular plate assembly having a small vertical dimension compared to the horizontal dimension of the rectangle and can be provided with a plurality of acoustic emitters, the plate assembly being sufficiently wide to span the wafer-bearing portion of the cassette 34. The acoustic emitters are driven in phase to generate a collimated acoustic beam that is directed along a centrally radiating axis (CRA) extending generally perpendicularly to the rectangular plate, as shown in FIG. 9. The acoustic energy is emitted generally uniformly along the length of the rectangular plate assembly, forming a generally planar, collimated beam that is directed toward the vane 38. The in-phase, collimated CRA beam reduces the distance at which the near-field acoustic zone transitions to the far-field. Note that the distance to the far-field varies with the square of the transducer dimension D, as described above in the equation for Z_{TR}. It has been observed that the value of D for the in-phase, collimated CRA beam is approximately equal to the short side dimension of the rectangular transducer assembly. This effect yields a shorter Z_{TR} distance; indeed, this distance is decreased sufficiently so that it is achievable in a path length provided by the folded acoustic path defined by the reflector element. Thus there is a synergy created by the combination of the reflector element and the in-phase, collimated CRA acoustic beam.

In the embodiments of FIGS. 9-12, the surfaces of the reflector or the facets of the prism (FIG. 12) may be provided with one or more surface treatments that affect the acoustic energy reflected therefrom. The surfaces may be dimpled, lenticular, bead-blasted, or the like to diffuse the acoustic energy field. Likewise the surface treatment may comprise curved faces that serve to focus or spread the incident acoustic beam to achieve desired directional control and power density levels. It is also noted in FIG. 12 that the prism 41, although depicted as a triangular polyhedron, may comprise other polyhedral configurations, or may have a tubular, cylindrical or elliptical configuration.

With regard to FIG. 13, one potential drawback to the use of a reflector 46 to attain a far-field path length for the acoustic beam is that the acoustic energy is directed upwardly at some moments toward the liquid/gas interface at the top of the tank. The interface is capable of reflecting a substantial amount of acoustic energy downwardly, which may cause the reflected energy at certain angles to be directed through the primary output beam as it emerges from the transducer 37. This secondary acoustic energy is capable of disruption of the primary acoustic beam by destructive, out of phase interference of the secondary wave front, indicating that crossing two or more acoustic beams is not desirable, and should be avoided.

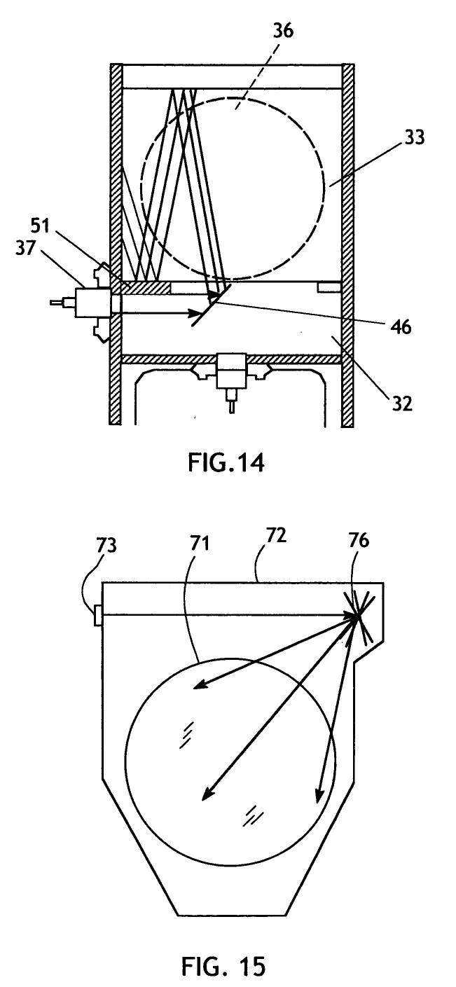

With reference to FIG. 14, one solution to the problem posed with regard to FIG. 13 is the addition of a baffle plate 51 disposed in the sump region of the tank. As shown in broken line in FIG. 10, the baffle plate 51 extends horizontally approximately the same length as the transducer 37, and is oriented in a horizontal plane directly above the transducer 37. The baffle 51 is dimensioned to be reflective of the megasonic wavelength used, and is positioned to re-reflect the acoustic energy that is reflected from the liquid/gas interface at the top of the tank. The baffle thus protects the throat area adjacent to the transducer 37 from disruption of the reflected acoustic beam.

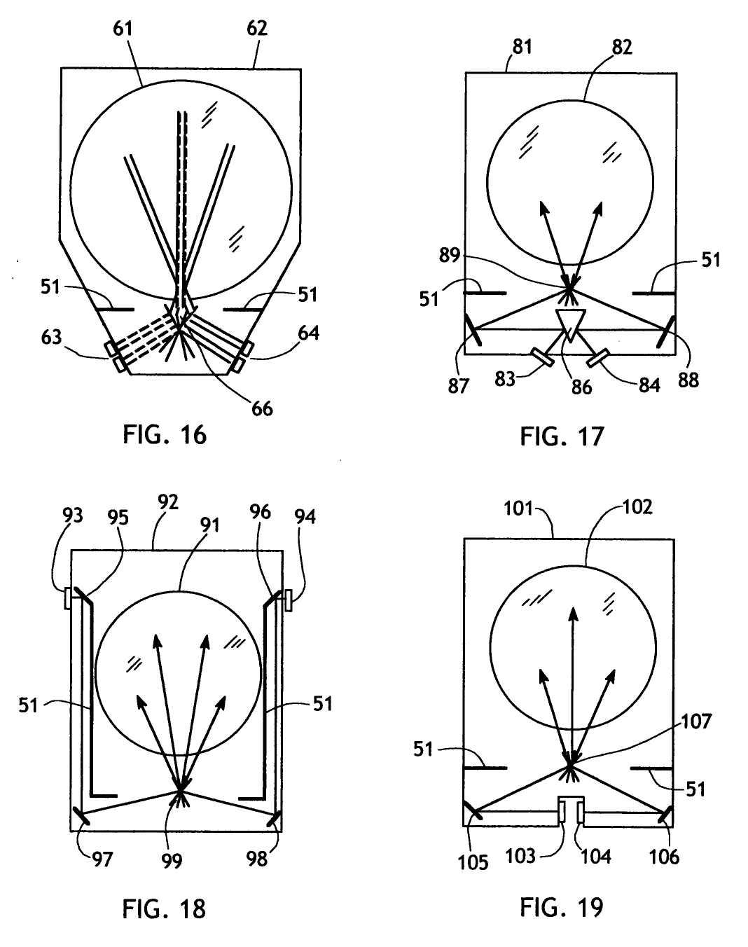

Defining an acoustic path length that is greater than Z_{TR} may be achieved using more than one acoustic reflector. With reference to FIG. 16, a wafer (or wafers) 61 may be immersed in a tank 62 that has two sets of megasonic transducers 63 and 64 disposed on opposite sides in the sump portion 65 thereof. A reciprocally rotatable reflector or refractor 66 (vane, prism, or the like) is disposed intermediate the transducers 63 and 64 and positioned in the zone where the acoustic paths of the two transducers converge. In this arrangement the reflector 66 is positioned so that the two transducers 63 and 64 are aimed obliquely away from each other, so that the output of one transducer cannot impinge directly on the other. Typical of other arrangements described previously, baffles 51 are installed above the transducer 63 and 64 to eliminate disturbance from the reflected beam from the surface. The element 66 is configured to sweep the acoustic beams from the transducers in a CRA across the surfaces of the wafers 61 and deliver the acoustic energy in a very uniform distribution. And, as noted above, the folded path length of the acoustic beams created by the reflector is greater than the transition zone Z_{TR} distance, so that the wafers are processed entirely in a megasonic far-field region. This results in a maximum amount of cleaning action with a minimum amount of physical damage to small-scale structures on the wafer.

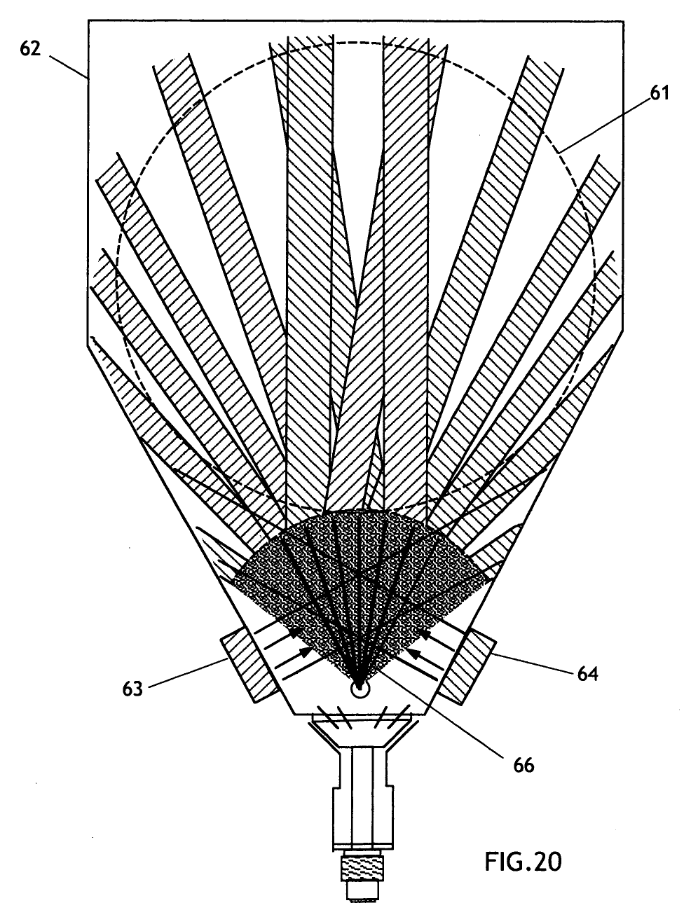

Note that the arrangement of FIG. 16 permits the introduction of greater acoustic power (twice the number of transducers compared to previous embodiments). Furthermore, it requires a smaller angular excursion by the element 66, which may permit better energy distribution across the wafer surfaces. With regard to FIG. 20, the two sets of transducers are provided with respective shading, and their reflected beams are shown in their respective shading as well. This diagram portrays the complete and overlapping coverage without crossover (one beam follows the other and can not cross) of the acoustic beams, which yields superior cleaning action.

With regard to FIG. 15, one or more wafers 71 may be processed in a tank 72 filled with solvent or solution. A transducer 73 is disposed above the wafers 71 and secured to one wall of tank beneath the upper surface of the liquid. A reciprocally rotatable element 76 (vane, prism, or the like) is mounted on an opposite wall of the tank 72 in the path of the acoustic beam from the transducer 73. The element 76 is constructed to reflect or refract the incident beam downwardly at a varying oblique angle creating a CRA to sweep the beam across the wafer surfaces in a uniform manner. As noted above, the folded path length of the acoustic beams created by the element 76 is greater than the transition zone distance Z_{TR}, so that the wafers are processed entirely in a megasonic far-field region.

With reference to FIG. 17, another multi-segment acoustic path arrangement includes a megasonic processing tank 81 and at least one wafer 82 immersed therein. A pair of transducers 83 and 84 are disposed beneath the wafer and aimed obliquely upwardly. A fixed prism 86 is disposed beneath the wafer 82 at the convergence point of the two acoustic beams, so that each beam impinges on an opposed side of the prism. The acoustic beam is thus reflected or refracted to opposite sides of the tank, where each beam strikes a respective reflector 87 and 88. These reflectors are each protected by a baffle 51 to keep destructive acoustic energy from interfering with their beam path. The reflectors are aimed to direct the acoustic beams to a reciprocally rotatable element 89 (vane, prism, or the like), which in turn sweeps the beams across the surfaces of the wafer(s) in a CRA with a very uniform distribution of acoustic energy. This embodiment provides the higher energy levels of two transducers, and a very long path length composed of 4 segments, whereby even a high value for Z_{TR} can be exceeded in a practical megasonic bath arrangement.

FIG. 18 depicts another multi-reflector arrangement in which at least one wafer 91 is immersed in a megasonic processing tank 92. A pair of transducers 93 and 94 are mounted on opposed sides of the tank at an upper portion thereof, and are directed toward adjacent fixed reflectors 95 and 96, respectively. These reflectors direct their beams to secondary fixed reflectors 97 and 98, respectively. The resulting beams are convergent on a reciprocally rotatable element 99 (vane, prism, or the like), which in turn sweeps the beams across the surfaces of the wafer(s) with a CRA in a very uniform distribution of acoustic energy. The addition of L-shaped baffles 51 are required adjacent to the downward vertical path of the beams in order to eliminate the CRA beam from disrupting the downward beams. This arrangement provides a long path length as in the embodiment of FIG. 17, and the power of two transducers, as well as the other attributes noted above.

With regard to FIG. 19, a further multi-reflector arrangement includes a megasonic processing tank 101 in which at least one wafer 102 is immersed. A pair of transducers 103 and 104 are mounted beneath the wafers 102 and directed to fire laterally in opposite directions toward opposed sides of the tank. A pair of fixed reflectors 105 and 106 are disposed at the opposed sides of the tank in the beam path of a respective transducer 103 or 104. Above these fixed reflectors are baffles 51 to protect against the surface reflections. The two reflectors are oriented to direct the respective beam toward a reciprocally rotatable element 107 that is mounted directly below the wafers 102. The moving element 107 reflects or refracts the beam and causes the beams to scan in a CRA across the surfaces of the wafers and carry out megasonic cleaning in the far-field acoustic region. This arrangement provides a path length longer than the embodiments of FIG. 9 or 12, and the power of two transducers, as well as the other attributes noted above.

In the embodiments of FIGS. 15-19 the transducers that are employed are matched to the reflectors that are provided, in terms of the width of the transducer and the reflector characteristics such as width, surface treatment, and facets for focusing or defocusing the acoustic beam, whereby the maximum acoustic energy is directed toward the wafer surfaces in the far-field region in as uniform a distribution as possible.

Thus in summary the invention provides an empirical scientific basis for performing megasonic cleaning in the far-field region, and further describes methods and apparatus for carrying out the far-field cleaning in practical devices. It is also significant that all the various arrangements described herein for megasonic cleaning are capable of cleaning all surfaces of the substrates being treated, including front and back surfaces and the edges thereof. The only comparable megasonic cleaning processes in the prior art that are damage-free for structures as small as 45 nm are single wafer treatments that do not clean all surfaces; that is, they achieve poor results for back surfaces and edges.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A method for megasonic cleaning of substrates, including the steps of:
providing a tank holding a liquid therein and placing at least one substrate therein;
placing an acoustic transducer in the tank to emit a megasonic output therefrom;
defining an acoustic beam path from the transducer to said at least one substrate, said acoustic beam path having sufficient length to establish that said at least one substrate is located in the far-field region of the acoustic transducer.

2. The method for megasonic cleaning of claim 1, wherein said acoustic transducer includes at least one long, narrow transducer emitting a collimated, generally planar acoustic beam.

3. The method for megasonic cleaning of claim 2, wherein said defining step includes placing a first acoustic element in the acoustic beam path for re-directing the beam toward said at least one substrate.

4. The method for megasonic cleaning of claim 3, further including the step of rotating the first acoustic element reciprocally to sweep the acoustic beam from a centrally radiating axis over the surfaces of said at least one substrate.

5. The method for megasonic cleaning of claim 4, further including forming said first acoustic element as a vane having a long narrow reflecting surface disposed in said beam.

6. The method for megasonic cleaning of claim 4, further including forming said first acoustic element as a prism having at least one long narrow surface disposed in said beam.

7. The method for megasonic cleaning of claim 3, wherein said defining step further includes interposing a second acoustic element in the acoustic beam path between the acoustic transducer and said at least one substrate, the second acoustic element reflecting the beam toward the first acoustic element.

8. The method for megasonic cleaning of claim 1, further including the step of providing a plurality of said long, narrow transducers in a spaced apart, parallel array, and orienting said at least one substrate generally orthogonally to said plurality of transducers to establish the far-field region for said at least one substrate.

9. The method for megasonic cleaning of claim 1, further including the step of providing a plurality of small, point-source-like transducers in a regular array aimed directly at said at least one substrate.

10. The method for megasonic cleaning of claim 1, further including the step of providing a baffle plate disposed in the tank adjacent to said transducer, the baffle plate disposed to block acoustic energy reflected from the upper surface of the liquid from interfering with the acoustic beam emitted from said transducer.

11. An apparatus for megasonic cleaning of substrates, including:
a tank containing a liquid and at least one substrate;
acoustic transducer means for emitting a megasonic output;
means for defining an acoustic beam path from said transducer means to said at least one substrate, said acoustic beam path having sufficient length to establish that said at least one substrate is located in the far-field region of the acoustic transducer.

12. The apparatus for megasonic cleaning of substrates of claim 11, wherein said acoustic transducer includes at least one long, narrow transducer emitting a collimated, generally planar acoustic beam.

13. The apparatus for megasonic cleaning of substrates of claim 1, wherein said means for defining an acoustic beam path includes a first acoustic element disposed in the acoustic beam path and redirecting the beam toward said at least one substrate.

14. The apparatus for megasonic cleaning of substrates of claim 13, further including means for rotating said first acoustic element reciprocally to sweep the acoustic beam from a centrally radiating axis across the surfaces of said at least one substrate.

15. The apparatus for megasonic cleaning of substrates of claim 14, wherein said first acoustic element comprises a vane having a long narrow reflecting surfaced disposed in said beam.

16. The apparatus for megasonic cleaning of substrates of claim 14, wherein said first acoustic element comprises a prism having at least one long narrow surface disposed in said beam.

17. The apparatus for megasonic cleaning of substrates of claim 13, wherein said means for defining an acoustic path includes a second acoustic element interposed in the acoustic beam path between the acoustic transducer and said at least one substrate, said second acoustic element redirecting the beam toward said first acoustic element.

18. The apparatus for megasonic cleaning of substrates of claim 12, wherein said means for defining an acoustic path includes a plurality of said long, narrow transducers disposed in a spaced apart, parallel array, said at least one substrate being oriented generally orthogonally to said plurality of transducers to establish the far-field region for said at least one substrate.

19. The apparatus for megasonic cleaning of substrates of claim 11, wherein said means for defining an acoustic path includes a plurality of small, point-source-like transducers in a regular array aimed directly at said at least one substrate.

20. The apparatus for megasonic cleaning of substrates of claim 11, further including baffle plate means disposed in the tank adjacent to said transducer for blocking acoustic energy reflected from the upper surface of the liquid from interfering with the acoustic beam emitted from the transducer.

21. The apparatus for megasonic cleaning of substrates of claim 11, wherein said far-field region is spaced apart from said acoustic transducer by a distance greater than Z_{TR}=D²/4λ, where D is the smaller of the two rectangular dimensions of said acoustic transducer and λ is the wavelength of the megasonic output.

22. The apparatus for megasonic cleaning of substrates of claim 14, wherein said acoustic beam impinges on and concurrently cleans the front and back surfaces and edges of said at least one substrate without causing sonic induced damage to sub-micron (˜45 nm) device structures.
